(19) United States
(12) Patent Application Publication
(10) Pub. No.: US 2014/0083111 A1
(43) Pub. Date: Mar. 27, 2014

(54) GAS TURBINE ASYMMETRIC FUEL NOZZLE COMBUSTOR

(71) Applicant: UNITED TECHNOLOGIES CORPORATION, Hartford, CT (US)

(72) Inventors: Shawn J. Gregg, Wethersfield, CT (US); Kevin K. Low, Portland, CT (US)

(73) Assignee: UNITED TECHNOLOGIES CORPORATION, Hartford, CT (US)

(21) Appl. No.: 13/626,523

(22) Filed: Sep. 25, 2012

(51) Int. Cl. F02C 7/24; F23R 3/28

(52) U.S. Cl. 60/779; 60/740

(57) ABSTRACT

A combustor of a gas turbine engine includes a multiple of fuel nozzles arranged asymmetrically

### BACKGROUND

The present disclosure relates to a gas turbine engine and, more particularly, to a combustor therefor.

Gas turbine engines, such as those that power modern commercial and military aircraft, generally include a compressor to pressurize an airflow, a combustor for burning a hydrocarbon fuel in the presence of the pressurized air, and a turbine for extracting energy from the resultant combustion gases. The combustor generally includes radially spaced inner and outer liners that define an annular combustion chamber therebetween. Arrays of circumferentially distributed combustion air holes penetrate multiple axial locations along each liner to radially admit the pressurized air into the combustion chamber. A plurality of circumferentially distributed fuel nozzles project symmetrically into a forward section of the combustion chamber through a respective fuel nozzle guide to supply the fuel to be mixed with the pressurized air.

Combustion chambers are symmetric in design with fuel nozzles equally spaced therearound which may amplify the vibration characteristics of the combustor and may result in audible noise under some conditions. This is often referred to as “hoot” and “howl”. This phenomena is managed by the fuel delivery system in that the fuel nozzles are supplied differently, such that fuel flow can be uniquely increased or decreased.

### SUMMARY

A combustor of a gas turbine engine according to one disclosed non-limiting embodiment of the present disclosure includes a multiple of fuel nozzles arranged asymmetrically

In a further embodiment of the foregoing embodiment, the multiple of fuel nozzles define a first multiple of fuel nozzles over a 180 degree arc and a second multiple of fuel nozzles over a second 180 degree arc, the first multiple different than the second multiple.

In a further embodiment of any of the foregoing embodiments, the multiple of fuel nozzles define a first multiple of fuel nozzles over an arc adjacent to an igniter and a second multiple of fuel nozzles over a remainder of the combustor. In the alternative or additionally thereto, in the foregoing embodiment the first multiple of fuel nozzles includes three (3) fuel nozzles. In the alternative or additionally thereto, in the foregoing embodiment the arc adjacent to the igniter is approximately 45 degrees.

In a further embodiment of any of the foregoing embodiments, the multiple of fuel nozzles define a seven (7) fuel nozzles over a 180 degree arc and eight (8) fuel nozzles over a second 180 degree arc.

In a further embodiment of any of the foregoing embodiments, the multiple of fuel nozzles define three (3) fuel nozzles over an arc adjacent to each of two (2) igniters and twelve (12) fuel nozzles over a remainder of the combustor.

A combustor of a gas turbine engine according to another disclosed non-limiting embodiment of the present disclosure includes a first multiple of fuel nozzles over a first arc around a combustor and a second multiple of fuel nozzles over a second arc around the combustor, the first multiple different than the second multiple.

In a further embodiment of the foregoing embodiment, the first arc is a 180 degree arc and the second arc is a 180 degree arc.

In a further embodiment of any of the foregoing embodiments, the first multiple of fuel nozzles is adjacent an igniter.

In a further embodiment of any of the foregoing embodiments, the first arc is less than 180 degrees.

A method of changing a vibration characteristic of a gas turbine engine combustor, according to another disclosed non-limiting embodiment of the present disclosure includes asymmetrically arranging a multiple of fuel nozzles.

In a further embodiment of the foregoing embodiment, the method includes arranging a first multiple of fuel nozzles over a first arc around a combustor; and arranging a second multiple of fuel nozzles over a second arc around the combustor, the first multiple different than the second multiple.

In a further embodiment of any of the foregoing embodiments, the method includes locating the first arc adjacent to an igniter.

In a further embodiment of any of the foregoing embodiments, the method includes spacing the first multiple of fuel nozzles to lean a fuel mixture.

In a further embodiment of any of the foregoing embodiments, the method includes spacing the first multiple of fuel nozzles to enrich a fuel mixture.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is a schematic cross-section of a gas turbine engine;

FIG. 2 is a partial sectional view of an exemplary annular combustor that may be used with the gas turbine engine shown in FIG. 1;

FIG. 3 is a sectional view along line A-A in FIG. 2 to show one non-limiting embodiment of a fuel nozzle configuration; and

FIG. 4 is a sectional view along line A-A in FIG. 2 to show another non-limiting embodiment of a fuel nozzle configuration.

### DETAILED DESCRIPTION

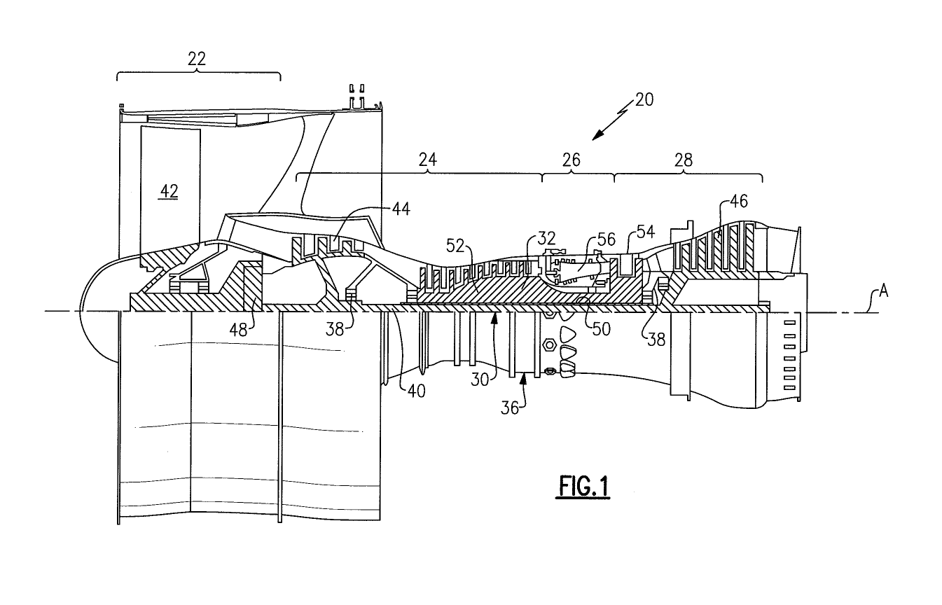

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmentor section (not shown) among other systems or features. The fan section 22 drives air along a bypass flowpath while the compressor section 24 drives air along a core flowpath for compression and communication into the combustor section 26 then expansion through the turbine section 28. Although depicted as a turbofan gas turbine engine in the disclosed non-limiting embodiment, it should be understood that the concepts described herein are not limited to use with turbofans as the teachings may be applied to other types of turbine engines such as a three-spool (plus fan) engine wherein an intermediate spool includes an intermediate pressure compressor (IPC) between the LPC and HPC and an intermediate pressure turbine (IPT) between the HPT and LPT, and industrial turbine engine applications.

The engine 20 generally includes a low spool 30 and a high spool 32 mounted for rotation about an engine central longitudinal axis A relative to an engine static structure 36 via several bearing structures 38. The low spool 30 generally includes an inner shaft 40 that interconnects a fan 42, a low pressure compressor 44 (“LPC”) and a low pressure turbine 46 (“LPT”). The inner shaft 40 drives the fan 42 directly or through a geared architecture 48 to drive the fan 42 at a lower speed than the low spool 30. An exemplary reduction transmission is an epicyclic transmission, namely a planetary or star gear system.

The high spool 32 includes an outer shaft 50 that interconnects a high pressure compressor 52 (“HPC”) and high pressure turbine 54 (“HPT”). A combustor 56 is arranged between the high pressure compressor 52 and the high pressure turbine 54. The inner shaft 40 and the outer shaft 50 are concentric and rotate about the engine central longitudinal axis A that is collinear with their longitudinal axes.

Core airflow is compressed by the low pressure compressor 44 then the high pressure compressor 52, mixed with the fuel and burned in the combustor 56, then expanded over the high pressure turbine 54 and low pressure turbine 46. The turbines 54, 46 rotationally drive the respective low spool 30 and high spool 32 in response to the expansion.

The main engine shafts 40, 50 are supported at a plurality of points by bearing structures 38 within the static structure 36. It should be understood that various bearing structures 38 at various locations may alternatively or additionally be provided.

In one non-limiting example, the gas turbine engine 20 is a high-bypass geared aircraft engine. In a further example, the gas turbine engine 20 bypass ratio is greater than about six (6:1). The geared architecture 48 can include an epicyclic gear train, such as a planetary gear system or other gear system. The example epicyclic gear train has a gear reduction ratio of greater than about 2.3, and in another example is greater than about 2.5:1. The geared turbofan enables operation of the low spool 30 at higher speeds which can increase the operational efficiency of the low pressure compressor 44 and low pressure turbine 46 and render increased pressure in a fewer number of stages.

A pressure ratio associated with the low pressure turbine 46 is pressure measured prior to the inlet of the low pressure turbine 46 as related to the pressure at the outlet of the low pressure turbine 46 prior to an exhaust nozzle of the gas turbine engine 20. In one non-limiting embodiment, the bypass ratio of the gas turbine engine 20 is greater than about ten (10:1), the fan diameter is significantly larger than that of the low pressure compressor 44, and the low pressure turbine 46 has a pressure ratio that is greater than about five (5:1). It should be understood, however, that the above parameters are only exemplary of one embodiment of a geared architecture engine and that the present disclosure is applicable to other gas turbine engines including direct drive turbofans.

In one embodiment, a significant amount of thrust is provided by the bypass flow path B due to the high bypass ratio. The fan section 22 of the gas turbine engine 20 is designed for a particular flight condition—typically cruise at about 0.8 Mach and about 35,000 feet. This flight condition, with the gas turbine engine 20 at its best fuel consumption, is also known as bucket cruise Thrust Specific Fuel Consumption (TSFC). TSFC is an industry standard parameter of fuel consumption per unit of thrust.

Fan Pressure Ratio is the pressure ratio across a blade of the fan section 22 without the use of a Fan Exit Guide Vane system. The low Fan Pressure Ratio according to one non-limiting embodiment of the example gas turbine engine 20 is less than 1.45. Low Corrected Fan Tip Speed is the actual fan tip speed divided by an industry standard temperature correction of “T”/518.7^{0.5}. in which “T” represents the ambient temperature in degrees Rankine. The Low Corrected Fan Tip Speed according to one non-limiting embodiment of the example gas turbine engine 20 is less than about 1150 fps (351 m/s).

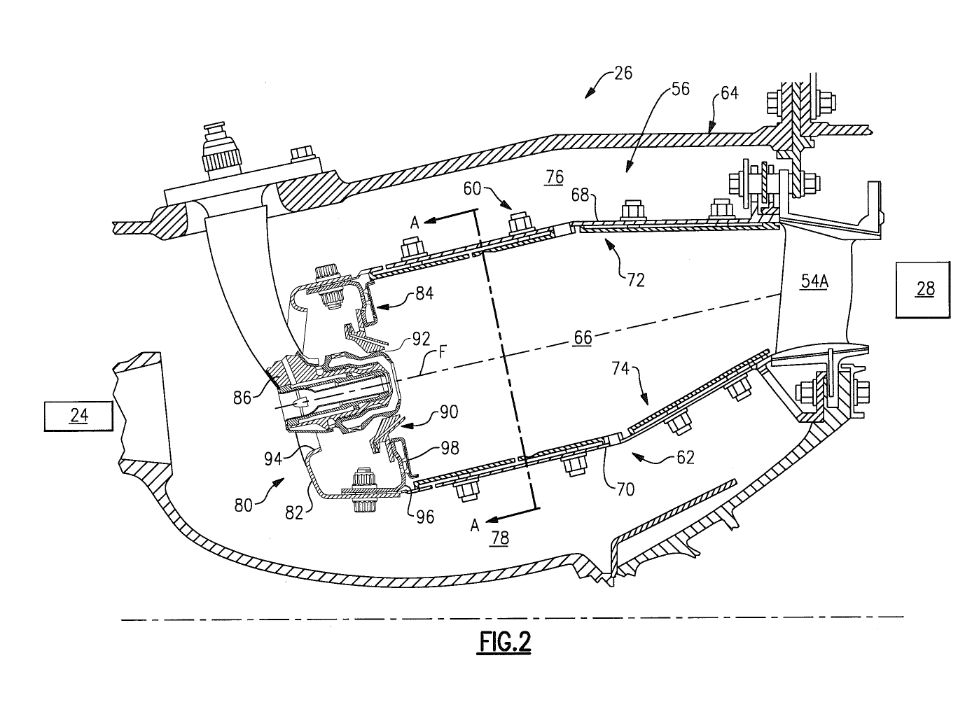

With reference to FIG. 2, the combustor 56 generally includes a combustor outer wall 60 and a combustor inner wall 62. The outer wall 60 and the inner wall 62 are spaced inward from a diffuser case 64 such that an annular combustion chamber 66 is defined there between. It should be understood that although a particular combustor is illustrated, other combustor types with various liner panel arrangements will also benefit herefrom.

The outer wall 60 and the diffuser case 64 define an annular outer plenum 76 and the inner wall 62 and the diffuser case 64 define an annular inner plenum 78. The outer and inner walls 60, 62 contain the flame for direction toward the turbine section 28. Each wall 60, 62 generally includes a respective support shell 68, 70 that supports one or more respective liner panels 72, 74 mounted to a hot side of the respective support shell 68, 70. The liner panels 72, 74 define a liner panel array that may be generally annular in shape. Each of the liner panels 72, 74 may be generally rectilinear and manufactured of, for example, a nickel based super alloy or ceramic material.

The combustor 56 further includes a forward assembly 80 immediately downstream of the compressor section 24 to receive compressed airflow therefrom. The forward assembly 80 generally includes an annular hood 82, a bulkhead assembly 84, a multiple of fuel nozzles 86 (one shown) and a multiple of fuel nozzle guides 90 (one shown) that defines a central opening 92. The annular hood 82 extends radially between, and is secured to, the forwardmost ends of the walls 60, 62. The annular hood 82 includes a multiple of circumferentially distributed hood ports 94 that accommodate the respective fuel nozzle 86 and introduce air into the forward end of the combustion chamber 66. Each fuel nozzle 86 may be secured to the outer case 64 and projects through one of the hood ports 94 and through the central opening 92 within the respective fuel nozzle guide 90 along a fuel nozzle axis F.

A multiple of Nozzle Guide Vanes (NGVs) 54A of the high pressure turbine 54 are located immediately downstream of the combustor 56. The NGVs 54A in one disclosed non-limiting embodiment, are the first static vane structure in the turbine section 28 of the gas turbine engine 20 upstream of a first turbine rotor. The NGVs 54A are static engine components which direct core airflow from the upstream combustor 56. The NGVs 54A direct core airflow combustion gases onto the turbine blades to facilitate the conversion of pressure energy into kinetic energy. The core airflow combustion gases from the combustor 56 are also accelerated by the NGVs 54A because of their convergent shape and are typically given a “spin” or a “swirl” in the direction of turbine rotor rotation. The turbine rotor blades absorb this energy to drive the turbine rotor at high speed.

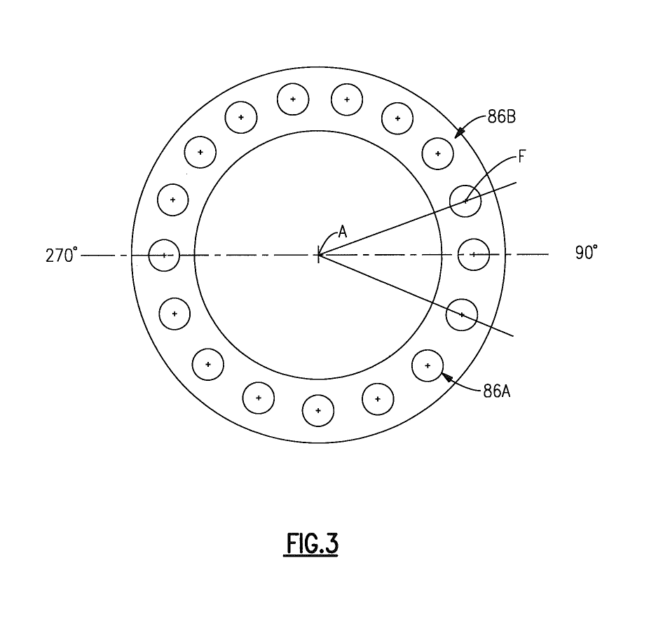

With reference to FIG. 3, a first multiple of fuel nozzles 86A are arranged between the 90 degree line and the 270 degree line (seven shown) while a second multiple of fuel nozzles 86B different than the first number are arranged between the 270 degree line and the 90 degree line (eight shown) around the engine central longitudinal axis A. It should be appreciated that any 180-degree arc may define the line of asymmetry. In both places where these configurations meet angle α and β, there is dissimilar circumferential spacing. In other words, the multiple of fuel nozzles 86A, 86B are arranged asymmetrically in a circumferential direction to provide non-uniform spacing which thus dampens potential combustor vibration amplification. It should be appreciated that other arcs such as 90-degree and 45-degree arcs may alternatively be provided.

The dissimilar spacing between fuel nozzles reduces the likelihood of combustor frequencies resonance to reduce noise. The “hoot” and howl” combustor noises are thereby minimized with static, non-actuating hardware that reduces fuels system complexity. This may result in a more cost effective fuel system that is also more reliable.

It should be appreciated that combustion dynamics in each of the fuel nozzle arrangements 86A, 86B may be different and may require unique volumes such as dissimilar inner and outer liner arrangements and/or dissimilar dilution and/or quench patterns.

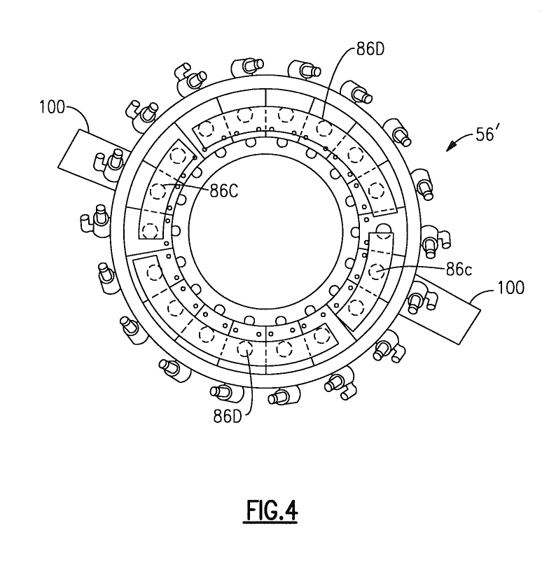

With reference to FIG. 4, a combustor 56′ according to another disclosed non-limiting embodiment locates a dissimilar number of fuel nozzles 86C over an arc adjacent to an igniter 100 (illustrated schematically) as compared to the number of fuel nozzles 86D over a circumferential remainder of the combustor 56′. In this disclosed non-limiting embodiment, three (3) fuel nozzles 86C are located in the arc adjacent to each igniter 100. In the arc adjacent to each igniter 100, for instance, the local spacing between fuel nozzles 86C may be reduced to provide a locally richer environment or the spacing may be increased to provide a locally leaner environment.

Although an annular style combustor arrangement is disclosed in the illustrated embodiment, it should be appreciated that individual can combustor arrangements will also benefit herefrom.

It should be understood that relative positional terms such as “forward,” “aft,” “upper,” “lower,” “above,” “below,” and the like are with reference to the normal operational attitude of the vehicle and should not be considered otherwise limiting.

It should be understood that like reference numerals identify corresponding or similar elements throughout the several drawings. It should also be understood that although a particular component arrangement is disclosed in the illustrated embodiment, other arrangements will benefit herefrom.

Although particular step sequences are shown, described, and claimed, it should be understood that steps may be performed in any order, separated or combined unless otherwise indicated and will still benefit from the present disclosure.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be understood that within the scope of the appended claims, the disclosure may be practiced other than as specifically described. For that reason the appended claims should be studied to determine true scope and content.

What is claimed is:

1. A combustor of a gas turbine engine comprising:
a multiple of fuel nozzles arranged asymmetrically

2. The combustor as recited in claim 1, wherein said multiple of fuel nozzles define a first multiple of fuel nozzles over a 180 degree arc and a second multiple of fuel nozzles over a second 180 degree arc, said first multiple different than said second multiple.

3. The combustor as recited in claim 1, wherein said multiple of fuel nozzles define a first multiple of fuel nozzles over an arc adjacent to an igniter and a second multiple of fuel nozzles over a remainder of said combustor.

4. The combustor as recited in claim 3, wherein said first multiple of fuel nozzles includes three (3) fuel nozzles.

5. The combustor as recited in claim 3, wherein said arc adjacent to said igniter is approximately 45 degrees.

6. The combustor as recited in claim 1, wherein said multiple of fuel nozzles define a seven (7) fuel nozzles over a 180 degree arc and eight (8) fuel nozzles over a second 180 degree arc.

7. The combustor as recited in claim 1, wherein said multiple of fuel nozzles define three (3) fuel nozzles over an arc adjacent to each of two (2) igniters and twelve (12) fuel nozzles over a remainder of said combustor.

8. A combustor of a gas turbine engine comprising:
a first multiple of fuel nozzles over a first arc around a combustor; and
a second multiple of fuel nozzles over a second arc around said combustor, said first multiple different than said second multiple.

9. The combustor as recited in claim 8, wherein said first arc is a 180 degree arc and said second arc is a 180 degree arc.

10. The combustor as recited in claim 8, wherein said first multiple of fuel nozzles is adjacent an igniter.

11. The combustor as recited in claim 8, wherein said first arc is less than 180 degrees.

12. A method of changing a vibration characteristic of a gas turbine engine combustor comprising:
asymmetrically arranging a multiple of fuel nozzles.

13. The method as recited in claim 12, further comprising arranging a first multiple of fuel nozzles over a first arc around a combustor; and arranging a second multiple of fuel nozzles over a second arc around the combustor, the first multiple different than the second multiple.

14. The method as recited in claim 13, further comprising locating the first arc adjacent to an igniter.

15. The method as recited in claim 13, further comprising spacing the first multiple of fuel nozzles to lean a fuel mixture.

16. The method as recited in claim 13, further comprising spacing the first multiple of fuel nozzles to enrich a fuel mixture.
